(19) United States
(12) Patent Application Publication
(10) Pub. No.: US 2011/0307301 A1
(43) Pub. Date: Dec. 15, 2011

(54) DECISION AID TOOL FOR COMPETENCY ANALYSIS

(75) Inventors: Jason Laberge, New Brighton, MN (US); Hari Thiruvengada, Plymouth, MN (US); Anand Tharanathan, Plymouth, MN (US)

(73) Assignee: Honeywell Internatioanl Inc., Morristown, NJ (US)

(21) Appl. No.: 13/157,853

(22) Filed: Jun. 10, 2011

Related U.S. Application Data
(60) Provisional application No. 61/353,353, filed on Jun. 10, 2010.

(51) Int. Cl. G06Q 10/00

(52) U.S. Cl. 705/7.39; 705/7.42

(57) ABSTRACT

A computer implemented method and system include receiving a trigger in the computer related to job performance in a work environment. The system compares job performance related to the trigger to a worker competency model having behavior indicators of good performance. The comparison of job performance to the worker competency model, behavior indicators, and outcome measures is used to provide an indication of good and poor job performance for a variety of situations. Training, best practices, and effective strategies may also be automatically identified.

### CROSS REFERENCE TO RELATED APPLICATION

The present application claims the priority benefit of U.S. Provisional Patent Application Ser. No. 61/353,353 filed on Jun. 10, 2010 and entitled “A DECISION AID TOOL FOR COMPETENCY ANALYSIS,” the contents of which are incorporated herein by reference in their entirety.

### TECHNICAL FIELD

The present disclosure relates to a system and method of aiding a decision-making related to the performance of a worker in a work environment.

### BACKGROUND

In large and complex work environments such as process control, worker (or other plant personnel) performance is assessed in many ways. One common approach is to evaluate worker performance after problems (or other triggers) occur. Specifically, when incidents or process upsets happen, a supervisor typically considers the performance of the individual worker(s) that were involved, and decides whether refresher training is required to address competency gaps. Currently, supervisors analyze worker competence and make refresher training decisions informally and subjectively. Feedback is rarely provided to workers and the decision is not transparent to the worker in terms of the rationale and/or justification for training needs. Another situation where performance is assessed is when workers perform well, exceeding targets/expectations, and supervisors want to understand best practices and strategies.

### BRIEF DESCRIPTION OF THE DRAWINGS

FIG. 1 is a block diagram of a system to implement a decision aid tool for competency analysis, according to various embodiments of the invention.

FIG. 2 is a flow diagram illustrating methods for implementing a decision aid tool for competency analysis, according to various embodiments of the invention.

FIG. 3 is a block diagram of a machine in the example form of a computer system, according to various embodiments of the invention.

FIG. 4A illustrates components of a structured training program, according to various embodiments of the invention.

FIG. 4B illustrates a training needs work process, according to various embodiments of the invention.

FIG. 4C illustrates an example Q&A sequence using an evidence-based approach for a Competency Analysis Decision Aid Tool (CADAT) tool, according to various embodiments of the invention.

FIG. 4D illustrates operator performance progression in a competency management program, according to various embodiments of the invention.

FIG. 5A illustrates a work process for negative trigger events, according to various embodiments of the invention.

FIG. 5B illustrates a work process for positive trigger events, according to various embodiments of the invention.

FIG. 5C illustrates conceptual relationships between responsibilities, competencies, behavior indicators, and recommended competency, according to various embodiments of the invention.

FIG. 5D illustrates a competency model, according to various embodiments of the invention.

### DETAILED DESCRIPTION

In the following description, reference is made to the accompanying drawings that form a part hereof, and in which is shown by way of illustration specific embodiments that may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or, in one embodiment, a combination of software and human implemented procedures. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, Application-Specific Integrated Circuit (ASIC), microprocessor, or other type of processor operating on a computer system, such as a personal computer, server or other computer system.

A decision aid tool helps supervisors and workers evaluate competencies for training opportunities or best practices/effective strategies. The tool may include a method to relate decisions to a comprehensive competency model with behavior indicators of good performance. The link between worker competency, behavior indicators, and outcome measures provides an objective, structured, and fully transparent approach to analyzing worker performance in a variety of situations.

The structured approach helps supervisors and workers identify training needs following different trigger events. Prior tools do not allow training decisions to be automated based on triggers from measures that can be measured automatically using internal applications or third party tools. Prior tools do not support triggers from multiple sources, including human judgments. Prior tools also do not structure training decisions around a full competency model to ensure comprehensive consideration of training needs. Prior tools do not rely on an evidence-based approach where the tool user (training evaluator) provides evidence for responses to questions presented automatically by the tool based on the competency model structure.

The decision aid tool may include at least one of the following features:

Different triggers (both positive and negative) can lead to using the tool to understand worker performance.

Triggers can come from a broad range of inputs, including supervisor and trainer observations and performance ratings measures, automated process measures, proprietary and third party tools, shift logs, incident reports, and the like.

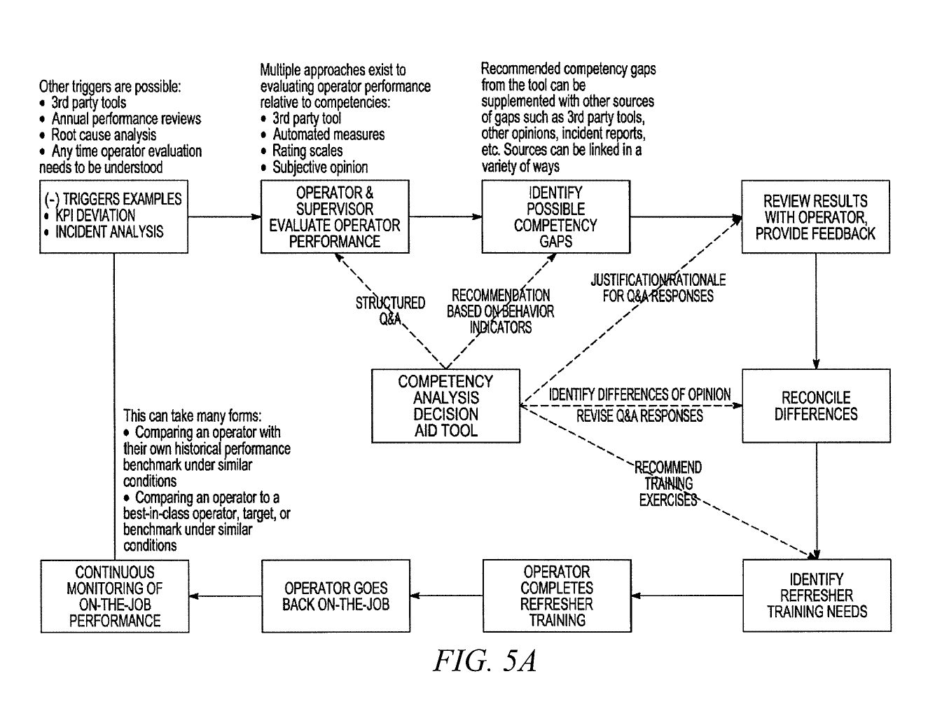

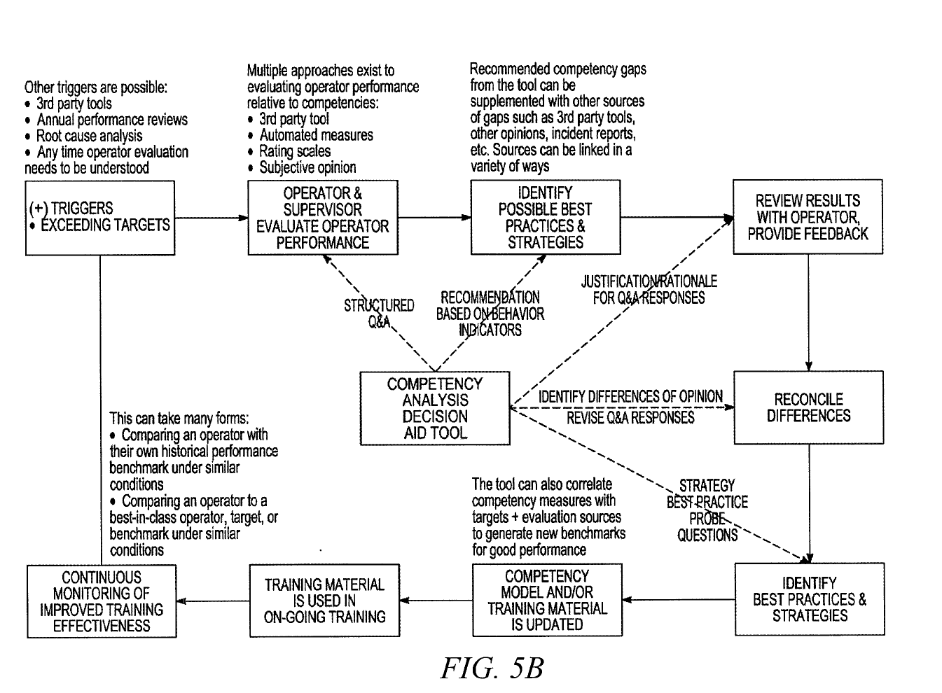

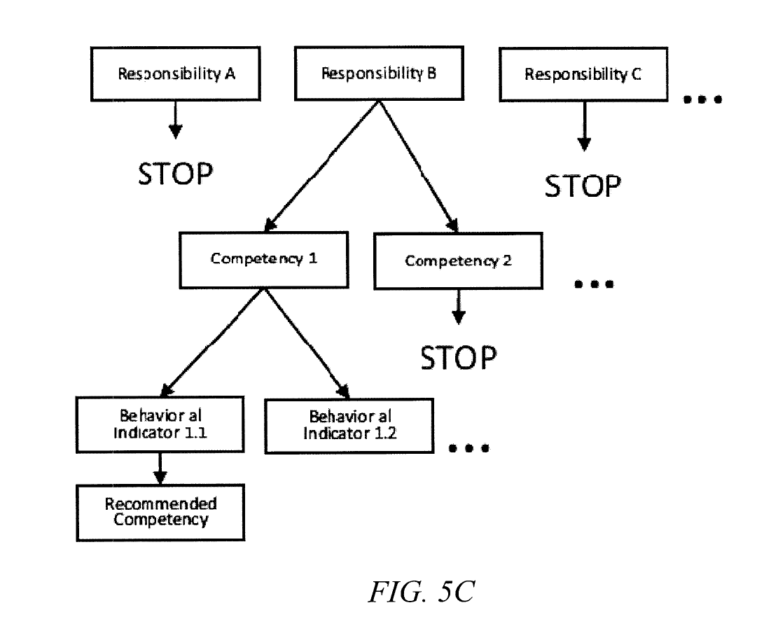

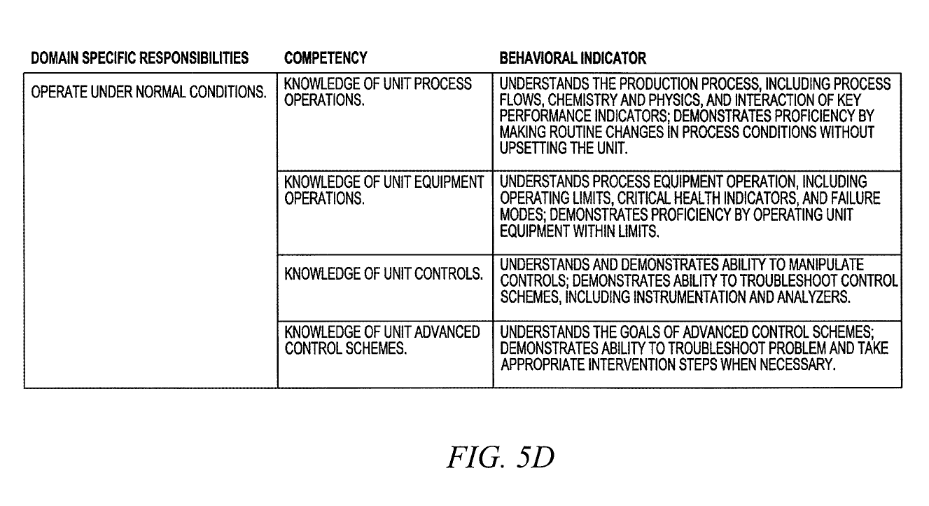

Links to a comprehensive competency model that lists the knowledge, skills, and attitudes expected for a worker to perform well during normal, abnormal and emergency situations (as illustrated in FIG. 5C).

Links to a competency model that describes expectations for performance at different levels of detail, such as worker responsibilities, competencies, and behavioral indicators (as also illustrated in FIG. 5C).

Flexibility to be adapted to different competency models, including customized models and models from different industries.

Links to behavioral indicators for each competency, which defines what good performance looks like (as illustrated in FIG. 5D).

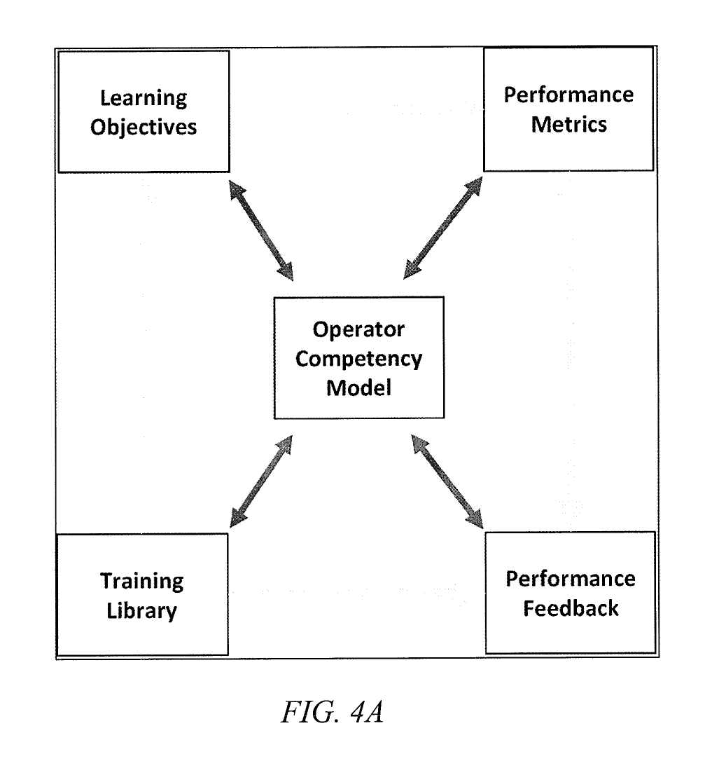

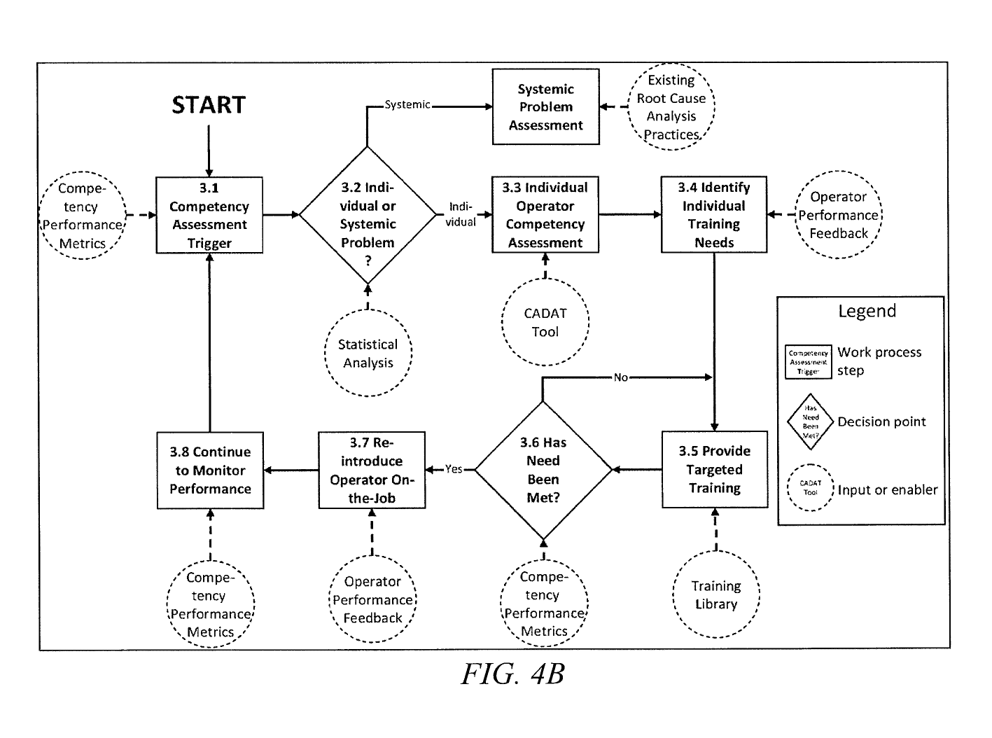

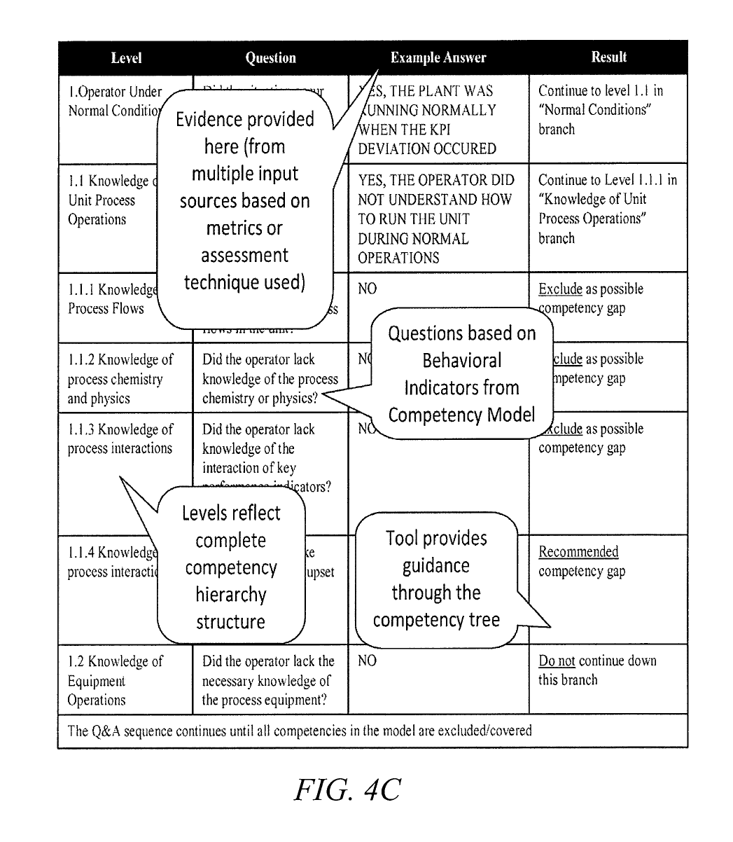

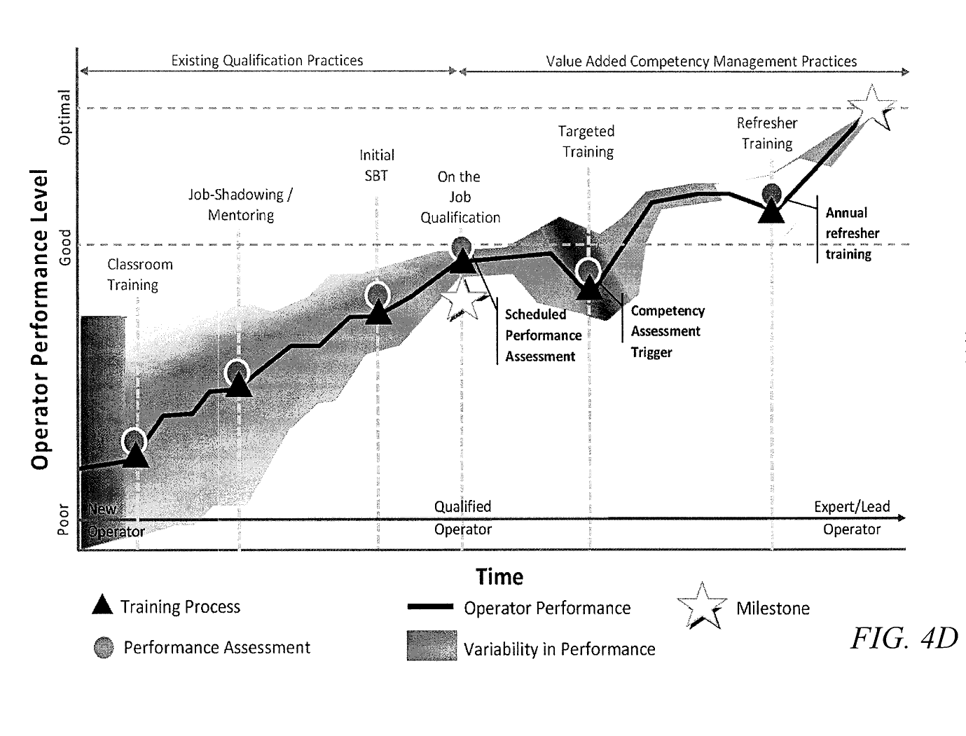

Structures the decision making process by asking supervisors and workers a series of questions for each competency in a sequential question and answer (Q&A) approach (as illustrated in FIG. 4C).

Supports alternative and mixed approaches to assessing worker performance, like automated evaluation based on process outcome measurement (i.e., control loop setpoint changes to measure control system knowledge), subjective ratings (1 to 10 scale where 1=does not demonstrate behavior and 10=fully demonstrates behavior), and 3rd party tools (i.e., some tools can assess alarm system performance which could be an indicator of operator alarm management competencies).

Includes competency related questions at different levels of detail to help the supervisor and worker hone in on the specific competencies that require refresher training or relate to best practices/strategies.

Includes more detailed probe questions to help reveal the best practices/strategies that underlie good performance on the job.

Identifies the most likely competency gaps that exist for the worker.

Identifies the most likely best/practice or strategy that underlies good performance.

Links to automated business rules and other functions/3rd party tools (such as a learning management system) that manage related work processes.

Includes links to one or more learning management systems that have training exercises for each competency in the model.

Recommend specific training exercises to complete based on the recommended competency gaps.

Includes a reconciliation feature where the responses to the questions by both supervisors and workers can be reviewed to identify discrepancies or differences of opinion.

Includes a feedback feature where supervisors can provide justification and/or the evidence for responses given to each question in the structured Q&A sequence or for any input to the competency evaluation protocol.

The tool may be configured to generate reports that may be used for ongoing performance assessment, certification, training records, and annual performance reviews.

The tool may be configured to generate reports at different hierarchical levels ranging from broad business outcomes to worker's individual task performance levels.

Helps the trainers in organizing their thought process more systemically while providing feedback to trainees.

This tool is different from the current approach in several ways. First, the structured Q&A approach provides a direct link to competencies and behavioral indicators, which can drive targeted training based on needs and gaps. Second, the tool makes the decision making process more objective compared to the current approach, which relies heavily on subjective supervisor observation, opinion and/or bias. Third, the tool can be used to identify best practices/strategies related to competencies and good performance. Fourth, both workers and supervisors may use the tool to provide a basis for understanding differences in performance assessment perspectives. Lastly, the tool can automatically recommend training exercises to address training needs by integrating with existing learning management systems and training libraries.

There may be various triggers that warrant a supervisor and/or worker using the tool. Triggers may be broadly categorized as either negative or positive. Negative triggers may initiate a work process whose goal is to understand competency gaps and training needs to remedy poor performance. Positive triggers may initiate a work process that aims to understand competency-related best practices and strategies that underlie good performance.

In various embodiments, as illustrated in FIG. 5A, the negative triggers may include:

Key Process Indicator (KPI) variation—if there is high variation on a process related outcome measure (e.g., product quality or unit throughput) limited to a single worker over time, the problem is likely related to individual competency. In contrast, if the high variation is consistent across multiple workers, the problem is not likely to be related to competency of the single worker alone but rather a systematic problem that may require a different approach, such as changes in management systems that are designed to solve the systemic problem.

Incident investigations—incidents may take many forms, from simple equipment trips to large scale explosions that cause injuries, deaths, facility damage, and environmental releases. Incidents are typically followed by investigations where worker performance is evaluated.

In negative trigger examples, the decision aid tool can help supervisors and workers understand competency gaps that should be addressed through refresher training.

In various embodiments, as illustrated in FIG. 5B, the positive triggers may include meeting or exceeding targets; workers who consistently exceed targets or benchmarks over time would be an example of a positive trigger. Unlike negative triggers, positive triggers result in a desire to understand worker best practices and strategies. The decision aid tool may be used to evaluate worker performance relative to competency to identify additional behavior indicators, new competencies, and/or effective strategies.

The tool may also account for other types of triggers, such as supervisor and trainer observations and performance ratings measures, automated process measures, proprietary and third part tools, shift logs, incident reports, and the like. In other words, the tool may be used whenever there is a desire to understand worker performance relative to competencies.

In one embodiment, when a trigger occurs, the tool may provide supervisors and/or workers with a structured Q&A sequence to help guide the decision making process relative to worker competency analysis. Each question is linked to a competency in the competency model so that the analysis is comprehensive relative to all expected worker competencies. The questions are also hierarchical in detail and are represented as a Q&A tree.

For negative triggers, affirmative answers at the lowest level of the tree imply a potential competency gap. Answers at the lowest level can include evidence, which means that the user (supervisor/trainer/workers) may provide evidence to support the answers he or she provided. Evidence can come from a variety of sources, including the original trigger event(s).

For positive triggers, affirmative answers at the lowest level imply a potential competency best practice or strategy. Additional follow-up or probe questions can be built into the tool used to hone in on the best practice and strategy.

Both supervisors and workers may go through the Q&A sequence so that both opinions/points of view may be captured. Other personnel may also use the tool, such as trainers (during training exercises), peer workers, etc. The supervisor may then review the responses with the worker and provide feedback and justification relevant to competency gaps/training needs or best practices/strategies. For training needs, the tool may integrate with one or more learning management systems to recommend specific training exercises that have been designed for each competency in the competency model. In that regard, the main output of the tool may be a recommended list of competencies that may be used to identify at least one of targeted training (for negative triggers) or best practices/strategies (for positive triggers).

Some embodiments described herein may comprise a system, apparatus and method of receiving a trigger in the computer related to job performance in a work environment. The system may compare job performance related to the trigger to a worker competency model, such as an operator competency model, having behavior indicators of good performance. The comparison of job performance to the worker competency model, behavior indicators, and outcome measures may be used to provide an indication of good and poor job performance for a variety of situations. Training, best practices, and effective strategies may also be automatically identified.

In various embodiments, the competency management framework may use a highly structured and comprehensive training program. As illustrated in FIG. 4A, a structured training program may be built around a core understanding of the operator competency hierarchy. At the highest level, the competency hierarchy may define the responsibilities of a worker, such as an operator. Related to each responsibility may be the competencies expected and the behavioral indicators that define how competencies can be observed by trainers. As noted earlier, these hierarchical relationship between the responsibilities, the competencies and the behavioral indicators are illustrated in FIG. 5C.

Another aspect of a structured program is the manner in which worker performance is assessed. Each behavioral indicator for a competency can be mapped to one or more performance measures in the training and work environment. When possible, performance measures may be an objective metric that can establish tangible benchmarks for acceptable performance. For instance, “Number of alarms per scenario” could be a metric to assess the “Managing alarms” competency where fewer than “X” alarms would indicate acceptable performance (see first row in Table 1). This example performance metric could be measured during training and on the job. Benchmarks for training and job performance can be established from historical data, expert opinion, industry consensus, or regulatory requirements, and the like.

In some cases, the appropriate performance metric may be based on subjective criteria (see second row in Table 1) because the behavioral indicators may not be overt and implicit and hence would be difficult to measure directly. Subjective metrics differ from objective metrics in that they rely on interpretation and judgment by evaluators. The evaluator in this context could be a supervisor, trainer, or a worker himself. Regardless of the specific metrics used, the key requirement for a structured training program is that each competency has at least one metric defined that can be used to assess worker performance.

TABLE 1
Mapping between responsibility, competency, behavioral
indicator, and performance metric, according to various
embodiments of the invention.

| | | | Performance |
|---|---|---|---|
| Responsibility | Competency | Behavioral Indicator | Metric |
| Anticipate | Managing | Demonstrate ability to | Number of |
| and respond | alarms | proactively monitor, | alarms per |
| to abnormal | | troubleshoot, and | scenario |
| conditions | | intervene in abnormal | |
| | | situations without | |
| | | relying on unit alarms | |
| Operate | Communicate | Effectively | Subjective |
| under normal | | communicate | rating on |
| conditions | | information to help | communication |
| | | maintain team | effectiveness |
| | | situation awareness | (1 = Low, |
| | | and anticipate | 10 = High) |
| | | abnormal conditions | |

In a structured program, measuring training outcomes using competency-specific metrics can provide workers with more detailed feedback on their training or job performance. Competency-specific feedback improves the current pass/fail practice by making the competency structure more tangible and, as a result, clearly communicates expectations, performance improvement opportunities and other decisions to workers. Providing feedback to workers can take many forms, including discussions during training, after-incident reviews with supervisors or trainers, and real-time on-screen feedback directly on the worker workstation.

The final component of a structured program may be a library of training exercises that supports appropriate learning objectives for the training method used. For Simulator Based Training (SBT) methods, a comprehensive library of training scenarios can be developed that focus on learning objectives for those competencies that are appropriately addressed using simulation-based techniques. For example, a training scenario designed to address the competency “Anticipate and respond to abnormal conditions” may include a learning objective “Recognize deviations in operating displays.” The training scenario may present workers with examples of different known plant upset conditions and ask workers to recognize and describe the deviations using trend displays. In this example, there may also be different scenario difficulty levels based on the complexity of the process upsets and the magnitude of impact on process values as shown in a trend display. More difficult scenarios may be based on rare and complicated upsets and/or subtle impacts on process values. A similar library of training exercises may be developed using other training techniques, such as classroom training, computer-based training (CBT), team training, field training, and on-the-job training.

The structured training program illustrated in FIG. 4A can easily support initial training requirements where a worker initially qualifies for a job using a variety of training techniques. However, despite adopting a structured program for initial training, there may remain a need to ensure that competency is sustained over time. Although refresher training may occur, the training typically covers the same learning objectives for all workers. As a result, individual operator training needs may be unmet, and this is often realized only after negative events occur. Therefore, a need remains in the industry to develop a mechanism for identifying individual worker training needs that can drive targeted training.

In various embodiments, a work process, as illustrated in FIG. 5B, may be employed to help supervisors and trainers answer a question: “Is there a competency problem that may be addressed?” Each step in the work process is described in more detail below. A key aspect of the work process is the use of a CADAT, which can support identifying individual worker training needs that can be addressed via targeted training.

Competency Assessment Trigger:

A number of trigger events can warrant asking the “competency problem” question. Each trigger event can drive the training needs work process, and using the CADAT tool can improve many current practices.

Process value variation—in the process industry, a tremendous amount of Process Value (PV) data is tracked using the Distributed Control System (DCS). Often, there are KPIs that are recorded and analyzed to assess how well the process plant is performing. However, monitoring PV/KPIs as an indicator of how well a worker is performing may not be a typical practice. When KPIs deviate beyond an established threshold, plant supervisors and trainers can use the targeted training work process and CADAT tool to better understand the individual worker training needs that could be driving the observed PV and KPI variation.

Incident investigation—incident investigations often consider worker competency and training needs as root causes of incidents. After incidents occur, the training needs work process and CADAT tool can improve current investigation practices by providing the structure and tools needed to comprehensively and consistently identify individual worker training needs.

Supervisor ratings—Supervisors in most work environment have keen insight into individual worker performance and training needs. When supervisors feel the need to evaluate individual workers, following the training needs work process and using the CADAT tool can help drive more consistency and provide workers with a more comprehensive assessment of their performance across the full range of worker competencies.

Monitoring tools—in addition to the process and KPIs that are tracked by the DCS, there are a number of other monitoring tools that record relevant indicators of operator performance. For instance, the number of display navigation moves by an individual operator may be an indirect indicator of operator situation awareness. When thresholds or limits are exceeded for any of the metrics tracked by existing monitoring tools, using the training needs work process and CADAT tool can help identify the competency gaps that are contributing to the limit violations.

Annual performance review—in most work environments, annual performance reviews are a common method for providing feedback on worker performance. However, performance reviews typically do not focus on worker competency, but instead focus on higher-level corporate goals, which can be difficult for workers to translate into specific changes in behaviors. Using the training needs work process and CADAT tool can complement existing annual performance review practices by providing workers with specific, comprehensive, and detailed feedback on their performance and training needs.

Refresher Training Performance—refresher training is a recognized best practice but effectiveness can be limited due to the generic nature of the training provided. However, the training needs work process and CADAT tool can be used by trainers to assess for individual worker performance deficiencies during refresher training exercises, which can result in targeted training based on individual worker needs.

Procedure Execution—the process industries is a highly procedural industry. Procedures provide the structured work instruction needed for workers to complete highly complex and time dependent activities. Metrics can be defined which may identify individual workers that need training for specific procedures. Using the CADAT tool could help reveal the competencies expected for effective procedural operations, which could inform general procedure-related training requirements.

Self-Assessments—few process plants provide workers with the opportunity to self-assess; however, such practices are more common in other work environments. The training needs work process and CADAT tool can help workers better identify their own training needs so that individuals can reach their highest performance potential.

Individual or Systemic Problem:

When a trigger occurs and there is evidence of a potential competency problem, another question that may be answered is whether the competency problem is a systemic or individual worker training opportunity. Some of the triggers lend themselves to identifying individual worker training needs directly. For instance, supervisor ratings and self-assessments are inherently focused on individual performance. However, when variation is observed in process values, KPIs, or other metrics, some additional analysis may be employed to determine whether there is an opportunity to improve individual or group performance.

Statistical analysis may be used to answer this question. If the observed variation in KPIs or other metrics is observed across a group of workers over time, then the conclusion may be that there is an opportunity to address a systemic problem with training. Examples of systemic training opportunities may be improvements in trainer competency, training delivery mechanisms, training material, competency model definitions, or training frequencies. Process plants may use their existing root-cause analysis and continuous improvement work processes to identify the specific systemic training program opportunities. If the statistical analysis identifies that the observed variation is limited to an individual worker over time, then the likely conclusion is that there is an opportunity to identify a worker's training needs. The rest of the training needs work process may help identify the specific need(s) expected for the individual worker.

Individual worker Competency Assessment:

The means of answering the question “Is there a competency problem that may be addressed?” may be supported by a CADAT. As illustrated in FIG. 4C, the CADAT tool supports supervisor and/or trainer assessments of worker competency and outputs potential gaps that could reflect training needs. Key features of the CADAT tool concept include:

Decision aiding—worker competency assessments are limited due to subjectivity, bias, and the fact that competency is not assessed in a comprehensive manner. The CADAT tool addresses these issues by acting as a decision aid for the supervisor or trainer to remove bias and subjectivity and ensure a comprehensive review.

Structured Q&A sequence—the tool enables a comprehensive competency review by structuring the competency assessment process using a Q&A sequence. The supervisors or trainers may be asked a series of questions at each level of the competency hierarchy. The Q&A approach ensures that the assessment covers all possible competencies. Responses at the lowest level of the Q&A sequence result in the identification of potential competency gaps. Similar Q&A techniques may be used for root cause analyses to ensure that all possible root causes of incidents are considered during an incident investigation.

Evidence-based assessment approach—the tool may use an evidence-based assessment approach, which means that the supervisor/trainer may be asked to provide evidence to support the answers provided in each branch of the Q&A sequence. Evidence may come from a variety of sources, including the original trigger event(s). An example Q&A sequence with evidence may be:
a. Competency: Managing alarms
b. Question from Q&A sequence: Did the operator encounter an alarm flood?
c. Answer from supervisor or trainer: Yes
d. Evidence for answer provided: Alarm logs from alarm monitoring tool showed that an alarm flood occurred based on benchmark of more than 10 alarms in a 10 minute period.

Enables feedback to worker—as mentioned previously, in one embodiment, comprehensive, specific and direct feedback to workers may be provided in the instant structured training program. The output of the CADAT tool can provide a basis for feedback to the worker. Supervisors, trainers, and workers can all review the results of the Q&A sequence, along with any evidence provided to support the identification of gaps and training needs.

Acts as competency record—responses to the Q&A sequence in the CADAT tool can supplement the worker's training and competency records. Applicants have realized that having more data available on individual worker performance can support more accurate and comprehensive performance reviews, which can better inform job-related decisions such as compensation changes, promotions, and changes to job assignments.

Drives targeted training—another value in using the CADAT tool is that the results of the Q&A sequence can help identify competency gaps that could reflect individual worker training needs that should be addressed using targeted training. The rest of the work process describes how targeted training can be achieved using the components of a structured training program described in FIG. 4A.

Identify Individual Worker Training Needs:

The next step in the work process may be to identify specific training needs based on the results of using the CADAT tool. As mentioned in the previous step, the CADAT tool may output competency gaps (based on evidence) that may reflect individual worker training needs. The decision on whether a training need exists may be done in consultation with the worker during a performance review feedback session. The worker feedback session may be employed because there are often extenuating circumstances that resulted in poor worker performance, and often those circumstances are not reflected in the competency assessment triggers or evidence provided. Workers may provide evidence, such as explanations, for competency gaps and supervisors and trainers can utilize the evidence to decide whether a training need does in fact exist.

Provide Targeted Training:

Once a training need has been identified, targeted training may be provided to address the need. Targeted training may be enabled, for example, via the training library that matches training material/exercises to specific competencies. Since the result of using the CADAT tool results in the identification of competency gaps, the appropriate training may be provided to address the gaps. This approach to training is considered targeted because the training targets specific competency gaps that reflect individual worker needs. Targeted training may contrast with initial or refresher training where all workers are presented with the same training material and curriculum.

Has the Need Been Met?

To assess whether the training need has been met, the trainer may use the established competency specific performance metric benchmarks. If the worker's performance during training exceeds the benchmark, the trainer can be confident that the need has been met. If performance is not at acceptable levels, the individual operator may be provided with additional targeted training until acceptable performance levels have been reached.

Re-Introduce Worker On-The-Job:

After the training need has been met, the worker may be put back on the job. However, the decision to pull a worker off shift for targeted training may be made by their supervisor and may depend on the nature of the competency gap. If the gap is considered severe, there may be a desire to provide immediate training. If the gap is considered less significant, the supervisor may opt to delay targeted training or allow the worker to complete the training while on shift. On-shift training is common practice on night shift when CBT modules and knowledge tests can be completed.

Continue to Monitor Performance:

One aspect to be considered for training is to assess whether training performance transfers to successful performance on the job. The targeted training work process may recommend monitoring individual worker performance after targeted training to ensure the training need has, in fact, been met. The specific metrics to monitor may depend on the competency gaps, but when possible, the same metrics that were used to assess performance during training may be used for monitoring transfer of training on the job.

Adopting a competency management framework that includes a structured approach to training, a work process that identifies individual training needs and a tool that can support competency assessments can provide many benefits. FIG. 4D illustrates what a structured worker training program might look like, with all training practices superimposed with worker performance levels. The chart shows that by considering worker competency as an ongoing competency management activity, individual worker performance is maximized and performance variability can be reduced over time.

Various embodiments described herein may comprise a system, apparatus and method of identifying an individual or group training need in response to a corresponding trigger. In the following description, numerous examples having example-specific details are set forth to provide an understanding of example embodiments. It will be evident, however, to one of ordinary skill in the art, after reading this disclosure, that the present examples may be practiced without these example-specific details, and/or with different combinations of the details than are given here. Thus, specific embodiments are given for the purpose of simplified explanation, and not limitation. Some example embodiments that incorporate these mechanisms will now be described in more detail.

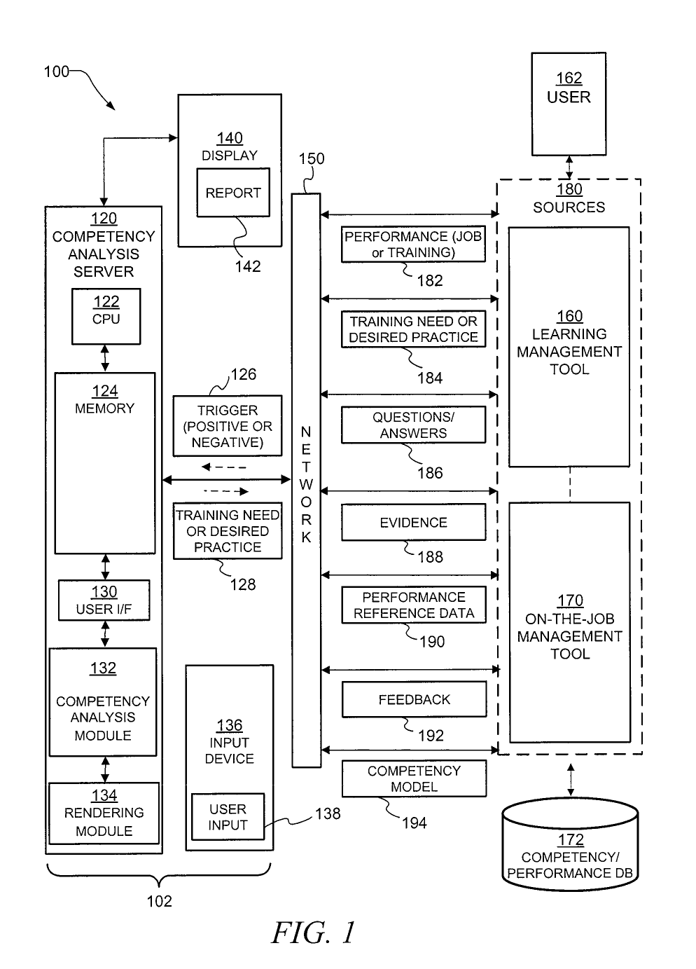

FIG. 1 is a block diagram of a system 100 to implement a decision aid tool for competency analysis, according to various embodiments of the invention. Here it can be seen that the system 100 used to implement the decision aid tool for competency analysis may comprise a competency analysis server 120 communicatively coupled with sources 180 of information, locally or remotely, such as via a network 150. The sources 180 may comprise a learning management tool 160 or an on-the-job management tool 170. The competency analysis server 120 may also be operatively coupled with a competency/performance database (DB), locally or remotely via the network 150 and/or the sources 180. The network 150 may be any suitable network, such as the Internet, and may be wired, wireless, or a combination of wired and wireless.

The competency analysis server 120 may comprise one or more central processing units (CPUs) 122, one or more memories 124, a user interface (I/F) module 130, a competency analysis module 132, a rendering module 134, one or more user input devices 136, and one or more displays 140.

At least one of the sources 180 may be accessible to a user 162, such as a supervisor or a worker (e.g., operator). The learning management tool 160 may keep track of performance information of one or more users for various trainings, such as classroom training, job shadowing or training with a console operator, and planned or remedial SBT. The on-the-job management tool 170 may keep track of performance information of users for a real job (e.g., operation of a plant facility) situation. The performance information may be stored in an associated storage device (not shown in FIG. 1) for later use. In one embodiment, the performance information may be stored in the competency/performance DB 172.

Any information managed by the learning management tool 160, the on-the-job management tool 170, or the competency/performance DB 172 may be provided to another system, such as the competency analysis server 120, directly or via the network 150, in response to receiving a request from the other system, or periodically without receiving any request from the other system. Likewise, any output of the processing by the competency analysis server 120 may be communicated to a corresponding one of the sources 180 directly or via the network 150.

In various embodiments, the competency analysis server 120 may comprise one or more processors, such as the one or more CPUs 122, to operate the competency analysis module 132. The competency analysis module 132 may be configured to receive at least one trigger 126 related to performance 182 of a worker in a work environment. The performance 182 of the worker may comprise information related to the worker's performance evaluation in a job-related training or a real job situation. The work environment may comprise a plurality of workers and a plurality of systems or tools, such as the learning management tool 160, the on-the-job management tool 170, the competency/performance DB 172, or the like. In one embodiment, the at least one trigger 126 may be received from the one or more of the sources 180 or provided as the user input 138.

The competency analysis module 132 may compare the performance related to the at least one trigger with a competency model 194. The competency model may comprise behavior indicators of good performance for a corresponding job or job training. The competency model may be provided from the sources 180, such as the competency/performance DB 172, from a user as a user input 138 via the input device 136. The competency analysis module 132 may then identify a training need (for the worker)/desired practice (for the work environment) 128 using an outcome of the comparison of the performance with the competency model. The identified training need or desired practice 128 may be presented as a report 142 via one or more displays 140, or communicated to one or more of the sources 180 directly or via a network, such as the network 150, as illustrated as the element 184.

In various embodiments, the at least one trigger 126 may comprise at least one of a positive trigger or a negative trigger. In various embodiments, the at least one trigger 126 may comprise at least one of a supervisor observation, a trainer observation, a performance rating measure, an automated process outcome measure, or an incident report. In various embodiments, the at least one trigger 126 may comprise a deviation in job performance beyond a specified threshold, such as 10% decrease or increase compared to the worker's own historical performance statistics or a benchmark worker's performance record, or the like.

In various embodiments, the competency model 194 may comprise knowledge, skills, or attitudes for one or more workers to perform well during normal, abnormal and emergency situations.

In various embodiments, for example, in identifying the training need, the competency analysis module 132 may be configured to identify one or more individual training exercises based on competency gaps identified from the comparison of the performance to the competency model 194.

In various embodiments, for example, in identifying the desired practice, the competency analysis module 132 may be configured to identify one or more benchmarks for the good performance based on competency gaps identified from the comparison of the performance to the competency model.

In various embodiments, for example, to perform the comparing between the performance 182 of the worker and the competency model 194, the competency analysis module 132 may be configured to collect answers 186 from a supervisor or a worker in response to a series of questions 186 for a corresponding competency. In one embodiment, one or more of the series of questions 186 may be structured to provide a direct link to a corresponding competency in the competency model 194.

In various embodiments, for example, to perform the comparing between the performance 182 of the worker and the competency model 194, the competency analysis module 132 may be configured to compare the answers 186 with the behavior indicators of the competency model 194.

In various embodiments, the competency analysis module 132 may be further configured to receive evidence 188 for at least one of the answers 186 provided by a corresponding one of the supervisor or the worker. In one embodiment, the evidence may comprise factual descriptions related to the at least one trigger, such as a description that the worker (e.g., operator) issued a certain number (e.g., three or five) of alarms in response to an emergency situation (e.g., gas leak or blackout, etc.).

In various embodiments, the competency analysis module 132 may be further configured to store the answers 186 in a memory, such as the one or more memories 124, associated with one or more processors, to supplement competency records for a corresponding one of the supervisor or the worker.

In various embodiments, the competency analysis module 132 may be further configured to present one or more of the answers 186 along with corresponding evidence via a display device associated with the one or more processors, such as the display 140.

In various embodiments, the competency analysis module 132 may be configured to compare the performance 182 with performance reference data 190. In one example embodiment, the performance reference data 190 to be compared with the performance 182 may comprise the worker's own historical performance. In yet another embodiment, the performance reference data 190 to be compared with the performance 182 may be at least one of a best-in-class worker's performance, a target performance, a benchmark performance, or the like. Other performance records may be used in addition to and/or instead of the performance reference data 190.

In various embodiments, the competency analysis module 132 may be further configured to receive feedback 192 regarding the training need or the desired practice 128 identified as a result of the comparison. In one embodiment, the feedback may comprise user feedback originating from a user, such as a supervisor or a worker. Then, responsive to detecting a difference in the feedback, the competency analysis module 132 may be further configured to reconcile the difference. In one embodiment, the reconciling may comprise revising corresponding one or more of the answers 186, for example, by presenting a corresponding user with the same or revised questions and receiving from the corresponding user one or more revised responses

In various embodiments, the competency analysis module 132 may be further configured to determine whether a competency problem associated with the at least one trigger 126 is related to an individual performance or a systemic performance. Then, the competency analysis module 132 may be configured to provide a recommendation for one or more group training exercises as the training need 128 based on a determination that the competency problem is related to the systemic performance

In various embodiments, the competency analysis module 132 may be further configured to determine whether the at least one trigger 126 is a positive trigger (e.g., an increase in performance) or a negative trigger (e.g., a decrease in performance). If the at least one trigger 126 is determined to be the negative trigger, then the competency analysis module 132 may be configured to identify a corresponding individual training need for the worker, for example, using the negative trigger. If the at least on trigger 126 is determined to be a positive trigger, then the competency analysis module 132 may be configured to identify a corresponding desired practice for the entire work environment to which the worker belongs, for example, using the positive trigger.

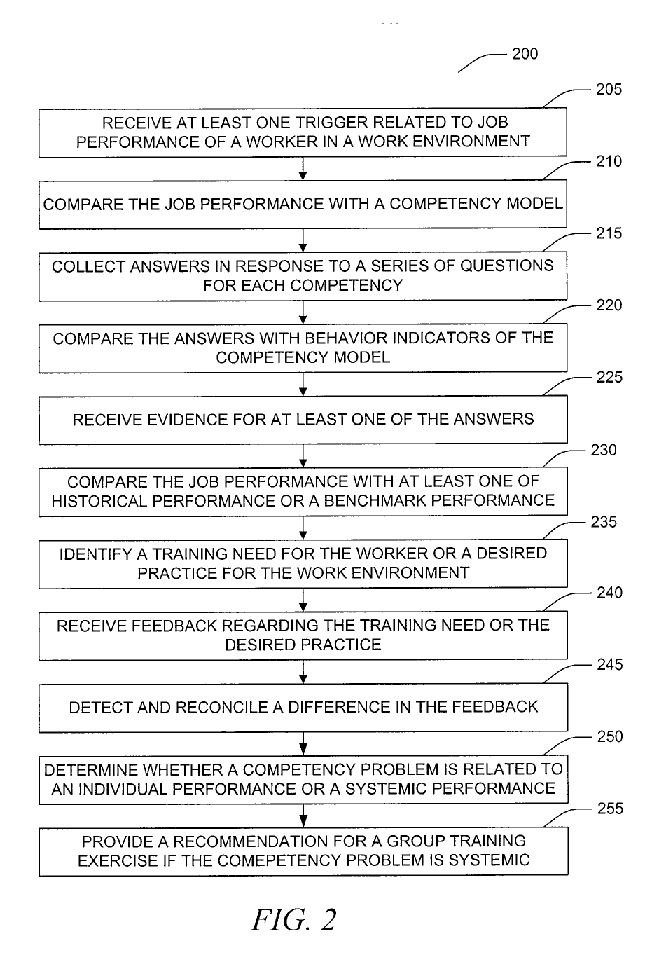

Each of the modules described above in FIG. 1 may be implemented by hardware (e.g., circuit), firmware, software or any combinations thereof. Although each of the modules is described above as a separate module, all of the modules or some of the modules in FIG. 1 may be implemented as a single entity (e.g., module or circuit) and still maintain the same functionality. Still further embodiments may be realized. Some of these may include a variety of methods. The system 100 and apparatus 102 in FIG. 1 can be used to implement, among other things, the processing associated with the method 200 of FIG. 2 discussed below.

FIG. 2 is a flow diagram illustrating methods of competency analysis, according to various embodiments of the invention. The method 200 may be performed by processing logic that may comprise hardware (e.g., dedicated logic, programmable logic, microcode, etc.), software (such as run on a general purpose computer system or a dedicated machine), firmware, or a combination of these. In one example embodiment, the processing logic may reside in various modules, such as the competency analysis module 132, illustrated in FIG. 1.

A computer-implemented method 200 that can be executed by one or more processors may begin at block 205 with receiving at least one trigger related to performance of a worker in a work environment. At block 210, using one or more processors, such as the one or more CPUs 122 in FIG. 1, the performance related to the at least one trigger may be compared with a competency model. In one embodiment, the competency model may comprise behavior indicators of good performance. Then, at block 235, a training need for the worker or a desired practice for the work environment may be identified using an outcome of the comparison of the worker's performance with the competency model.

In various embodiments, as depicted at block 215, the comparing may comprise collecting answers from a supervisor or a worker in response to a series of questions for a corresponding competency. In one embodiment, as illustrated in Table 1, one or more of the series of questions may be structured to provide a direct link to a corresponding competency in the competency model.

In various embodiments, as depicted at block 220, the comparing may comprise comparing the answers with the behavior indicators of the competency model.

In various embodiments, as depicted at block 225, the comparing may comprise receiving evidence for at least one of the answers provided by a corresponding one of the supervisor or the worker. In one embodiment, the evidence may comprise factual descriptions related to the at least one trigger.

In various embodiments, the comparing may comprise storing the answers in a memory associated with the one or more processors, for later use. In one embodiment, the storing may be to supplement competency records for a corresponding one of the supervisor or the worker (not shown in FIG. 2).

In various embodiments, the comparing may comprise presenting one or more of the answers along with corresponding evidence via a display device associated with the one or more processors (not shown in FIG. 2).

In various embodiments, as depicted at block 230, the comparing may comprise comparing the performance with at least one of a historical performance of the worker, a best-in-class worker's performance, a target performance, or a benchmark performance. In one embodiment, one or more of the historical performance of the worker, the best-in-class worker's performance, the target performance, or the benchmark performance may be provided from another source, such as the competency/performance DB 172 in FIG. 1.

In various embodiments, at block 240, once the identified training need or desired practice is communicated to a user, such as the worker or a supervisor of the worker, feedback regarding the training need or the desired practice may be received from a corresponding user. Then, at block 245, a difference in the feedback may be detected and the difference may be reconciled. In one embodiment, the reconciling may comprise revising a corresponding one or more of the answers.

In various embodiments, at block 250, it is determined whether a competency problem associated with the at least one trigger is related to an individual performance or a systemic performance. Then, at block 255, a recommendation for one or more group training exercises may be provided as the training need based on a determination that the competency problem is related to the systemic performance. In one embodiment, it is determined that the competency problem is related to the systemic performance rather than the individual performance when a certain number of workers in the same work environment are reported to go through similar deviations (e.g., decrease) in the same or similar job. For example, if four or five out of ten workers are reported to experience 10% or more decrease in the operation of a plant facility, then it may be determined that the performance problem associated with the operation of the plant facility is a systemic problem rather than the four or five workers' individual problems. The group training exercise may be deployed to the entire corresponding worker group in the worker environment.

In various embodiments, it may be determined whether the at least one trigger is a positive trigger (e.g., an increase in performance) or a negative trigger (e.g., a decrease in performance). If the at least one trigger is determined to be the negative trigger, then a corresponding individual training need for the worker may be identified and notified to the worker and/or the supervisor of the worker, for example, using the negative trigger. If the at least on trigger is determined to be the positive trigger, then a corresponding desired practice for the entire work environment to which the worker belong may be identified, for example, using the positive trigger.

Although only some activities are described with respect to FIG. 2, the computer-implemented method 200 may perform other activities, such as operations performed by the competency analysis module 132 of FIG. 1, in addition to and/or instead of the activities described with respect to FIG. 2.

The methods described herein do not have to be executed in the order described, or in any particular order. Moreover, various activities described with respect to the methods identified herein can be executed in repetitive, serial, heuristic, or parallel fashion. The individual activities of the method 200 shown in FIG. 2 can also be combined with each other and/or substituted, one for another, in various ways. Information, including parameters, commands, operands, and other data, can be sent and received in the form of one or more carrier waves. Thus, many other embodiments may be realized.

The method 200 shown in FIG. 2 can be implemented in various devices, as well as in a computer-readable storage medium, where the method 200 is adapted to be executed by one or more processors. Further details of such embodiments will now be described.

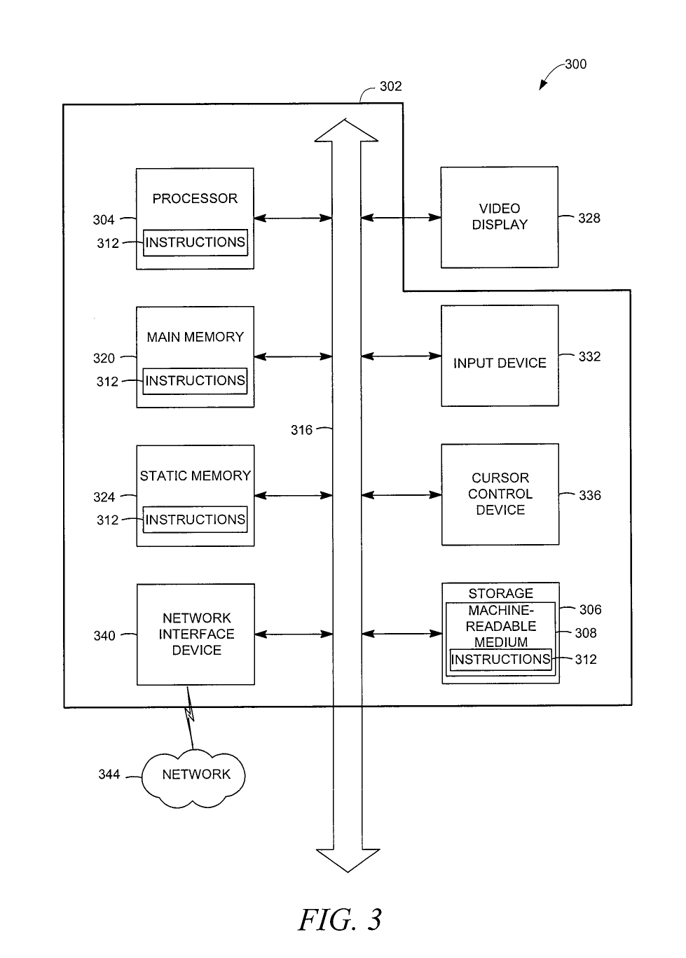

For example, FIG. 3 is a block diagram of an article 300 of manufacture, including a specific machine 302, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-oriented format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 300 of manufacture, such as a computer, a memory system, a magnetic or optical disk, some other storage device, and/or any type of electronic device or system may include one or more processors 304 coupled to a machine-readable medium 308 such as a memory (e.g., removable storage media, as well as any memory including an electrical, optical, or electromagnetic conductor) having instructions 312 stored thereon (e.g., computer program instructions), which when executed by the one or more processors 304 result in the machine 302 performing any of the actions described with respect to the methods above.

The machine 302 may take the form of a specific computer system having a processor 304 coupled to a number of components directly, and/or using a bus 316. Thus, the machine 302 may be similar to or identical to the apparatus 102 or system 100 shown in FIG. 1.

Returning to FIG. 3, it can be seen that the components of the machine 302 may include main memory 320, static or non-volatile memory 324, and mass storage 306. Other components coupled to the processor 304 may include an input device 332, such as a keyboard, or a cursor control device 336, such as a mouse. An output device such as a video display 328 may be located apart from the machine 302 (as shown), or made as an integral part of the machine 302.

A network interface device 340 to couple the processor 304 and other components to a network 344 may also be coupled to the bus 316. The instructions 312 may be transmitted or received over the network 344 via the network interface device 340 utilizing any one of a number of well-known transfer protocols (e.g., HyperText Transfer Protocol (HTTP) and/or Transmission Control Protocol (TCP/IP)). Any of these elements coupled to the bus 316 may be absent, present singly, or present in plural numbers, depending on the specific embodiment to be realized.

The processor 304, the memories 320, 324, and the mass storage 306 may each include instructions 312, which, when executed, cause the machine 302 to perform any one or more of the methods described herein. In some embodiments, the machine 302 operates as a standalone device or may be connected (e.g., networked) to other machines. In a networked environment, the machine 302 may operate in the capacity of a server or a client machine in server-client network environment, or as a peer machine in a peer-to-peer (or distributed) network environment.

The machine 302 may comprise a personal computer (PC), a tablet PC, a set-top box (STB), a personal digital assistant (PDA), a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 302 is illustrated, the term “machine” shall also be taken to include any collection of machines that individually or jointly execute a set (or multiple sets) of instructions to perform any one or more of the methodologies discussed herein.

While the machine-readable medium 308 is shown as a single medium, the term “machine-readable medium” should be taken to include a single medium or multiple media (e.g., a centralized or distributed database, and/or associated caches and servers, and/or a variety of storage media, such as the registers of the processor 304, memories 320, 324, and the mass storage 306 that store the one or more sets of instructions 312). The term “machine-readable medium” shall also be taken to include any medium that is capable of storing, encoding or carrying a set of instructions for execution by the machine 302 and that cause the machine 302 to perform any one or more of the methodologies according to various embodiments of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Various embodiments of the invention can be implemented in a variety of architectural platforms, operating and server systems, devices, systems, or applications. Any particular architectural layout or implementation presented herein is thus provided for purposes of illustration and comprehension only, and is not intended to limit the various embodiments.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
one or more processors operable to run a competency analysis module, the competency analysis module configured to:
receive at least one trigger related to performance of a worker in a work environment;
compare the performance related to the at least one trigger with a competency model, the competency model including behavior indicators of good performance; and
identify a training need for the worker or a desired practice for the work environment using an outcome of the comparison of the performance with the competency model.

2. The system of claim 1, wherein the at least one trigger comprises at least one of a positive trigger or a negative trigger.

3. The system of claim 1, wherein the at least one trigger comprises at least one of a supervisor observation, a trainer observation, a performance rating measure, an automated process outcome measure, or an incident report.

4. The system of claim 1, wherein the at least one trigger comprises a deviation in job performance beyond a specified threshold.

5. The system of claim 1, wherein the competency model comprises knowledge, skills, or attitudes for one or more workers to perform well during normal, abnormal or emergency situations.

6. The system of claim 1, wherein identifying of the training need comprises identifying one or more individual training exercises based on competency gaps identified from the comparison of the performance to the competency model.

7. The system of claim 1, wherein identifying of the desired practice comprises identifying one or more benchmarks for the good performance based on competency gaps identified from the comparison of the performance to the competency model.

8. A computer-implemented method comprising:
receiving at least one trigger related to performance of a worker in a work environment;
comparing, using one or more processors, the performance related to the at least one trigger with a competency model, the competency model including behavior indicators of good performance; and
identifying a training need for the worker or a desired practice for the work environment using an outcome of the comparison of the performance with the competency model.

9. The method of claim 8, wherein the comparing comprises collecting answers from a supervisor or a worker in response to a series of questions for a corresponding competency.

10. The method of claim 9, wherein one or more of the series of questions are structured to provide a direct link to a corresponding competency in the competency model.

11. The method of claim 9, wherein the comparing comprises comparing the answers with the behavior indicators.

12. The method of claim 9, wherein the comparing comprises receiving evidence for at least one of the answers provided by a corresponding one of the supervisor or the worker.

13. The method of claim 12, wherein the evidence comprises factual descriptions related to the at least one trigger.

14. The method of claim 9, wherein the comparing comprises storing the answers in a memory associated with the one or more processors, the storing to supplement competency records for a corresponding one of the supervisor or the worker.

15. The method of claim 12, wherein the comparing comprises presenting one or more of the answers along with corresponding evidence via a display device associated with the one or more processors.

16. The method of claim 8, wherein the comparing comprises comparing the performance with historical performance of the worker.

17. The method of claim 8, wherein the comparing comprises comparing the performance with at least one of a best-in-class worker's performance, a target performance, or a benchmark performance.

18. The method of claim 8, further comprising:
receiving user feedback regarding the training need or the desired practice identified as a result of the comparison; and
responsive to detecting a difference in the user feedback, reconciling the difference, the reconciling including revising a corresponding one or more of the answers.

19. The method of claim 8, further comprising:
determining whether a competency problem associated with the at least one trigger is related to an individual performance or a systemic performance; and
providing a recommendation for one or more group training exercises as the training need based on a determination that the competency problem is related to the systemic performance.

20. A non-transitory computer-readable storage medium storing instructions which, when executed by at least one processor, cause the at least one processor to perform operations comprising:
receiving at least one trigger related to performance of a worker in a work environment;
comparing the performance related to the at least one trigger to a competency model, the competency model including behavior indicators of good performance; and
identifying a training need for the worker or a desired practice for the work environment using an outcome of the comparison of the performance to the competency model.
